(19) United States
(12) Patent Application Publication
(10) Pub. No.: US 2016/0104368 A1
(43) Pub. Date: Apr. 14, 2016

(54) SOS QUICK CAPTURE

(71) Applicants: Robert Sullivan, New Smyrna Beach, FL (US); Lawrence Golsong, New Smyrna Beach, FL (US)

(72) Inventors: Robert Sullivan, New Smyrna Beach, FL (US); Lawrence Golsong, New Smyrna Beach, FL (US)

(21) Appl. No.: 14/882,682

(22) Filed: Oct. 14, 2015

Related U.S. Application Data
(60) Provisional application No. 62/128,167, filed on Mar. 4, 2015.
(60) Provisional application No. 62/063,686, filed on Oct. 14, 2014.

(51) Int. Cl. G08B 25/01; G06F 3/0484; G06F 3/0481

(52) U.S. Cl. CPC G08B 25/016; G06F 3/04817; G06F 3/04847; G06F 3/04842

(57) ABSTRACT

An emergency SOS application and system includes a portable electronic device that communicates over a network, and has a display screen, an actuation mechanism, a processor, a memory, location information, a microphone, a camera, and a speakerphone. The portable electronic device is encoded with an emergency SOS application that generates a plurality of screen icons, captures emergency information from each of the microphone, camera and speakerphone, activates a voice call from the device, and sends a plurality of data messages containing the captured emergency information.

### CROSS-REFERENCE TO RELATED APPLICATIONS

This application claims the benefit of U.S. Application Ser. No. 62/128,167 filed on Mar. 4, 2015 and U.S. Application Ser. No. 62/063,686 filed on Oct. 14, 2014, the contents of each of which are incorporated herein by reference.

### TECHNICAL FIELD

The present invention relates generally to emergency notification devices, and more particularly to an emergency SOS application which can be embedded within an electronic device that functions to notify others of an emergency situation.

### BACKGROUND

The statements in this section merely provide background information related to the present disclosure and may not constitute prior art.

Each year, millions of individuals around the globe find themselves in an emergency situation. Whether they are involved in an accident or are having a medical emergency, when trouble strikes, it is important to summon help as quickly as possible.

Owing to recent advances in technology, it is common for individuals to carry a cellular telephone on their person at all times. The use and availability of cellular telephones have saved countless lives, by enabling users to phone for help when such an emergency strikes.

Unfortunately, there are some emergency situations where there is not enough time to make a phone call. For example, if a person is the victim of an assault or other violent act, he or she may have only seconds to try to summon help. Even if they are successful in calling for help, by the time it arrives the assailant will most likely have already fled, thus requiring the victim to attempt to describe their attacker. Such a task can be exceedingly difficult for the victim, and if he or she is unconscious, the Police may have to wait hours or days before they can have an accurate description.

Accordingly, it would be beneficial to provide an emergency SOS application which can enable a user to quickly and easily report an emergency situation to others, wherein the report can include their exact location, as well as photographs and/or audio of the incident.

### SUMMARY OF THE INVENTION

The present invention is directed to an emergency SOS application and system. One embodiment of the present invention can include a portable electronic device that is configured to communicate over a network, and including a display screen, an actuation mechanism, a processor, a memory, location information, a microphone, a camera, and a speakerphone. The portable electronic device can be encoded with an emergency SOS application which can generate a plurality of screen icons, capture emergency information from each of the microphone, camera and speakerphone, activate a voice call from the device, and send a plurality of data messages containing the captured emergency information.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exemplary system operating environment that is useful for understanding the inventive concepts disclosed herein.

FIG. 2 is a schematic diagram listing several application modules, in accordance with one embodiment of the invention.

FIG. 3 shows an exemplary user interface of the system of FIG. 1.

FIG. 4 shows an exemplary flow diagram illustrating a method for utilizing the system of FIG. 1.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

Although the portable electronic device is described throughout this document as an existing user-owned smartphone device, the invention is not so limiting. To this end, those of skill in the art will recognize that any type of processor enabled device that is capable of capturing audio, video and/or location information, and can communicate the same with a secondary device and/or a human operator can be utilized herein. To this end, wearable communication devices such as smartwatches that can communicate with a paired cellular telephone and/or directly with a wireless network are particularly applicable. Several other nonlimiting examples include all types of cellular telephones, tablet computers, portable computers, PDAs, and/or portable music devices (MP3 players), for example.

Additionally, embodiments of the present system can also be performed wherein the portable electronic device comprises a purpose built machine that is pre-encoded with the emergency SOS application described below. This purpose built machine can include, comprise or consist of a smartphone that is purpose built to execute the emergency SOS application, and can preferably include a separate physical internal memory for storing the SOS application and the captured emergency data. Of course, the device and/or method steps are not to be construed as limiting to only a smartphone device.

As described herein, the term SOS Quick Capture shall encompass the below described system and application features of the invention. To this end, the below described emergency SOS application can preferably be presented in the form of a smartphone mobile application (i.e., App) which can be preloaded on a smartphone device, or downloaded and installed as an application after purchase of the smartphone device. Of course, the inventive concepts disclosed herein are not to be construed as limiting to a smartphone App, as virtually any type of instruction sets, in any form of programming language that can be executed on a processor enabled device are also contemplated.

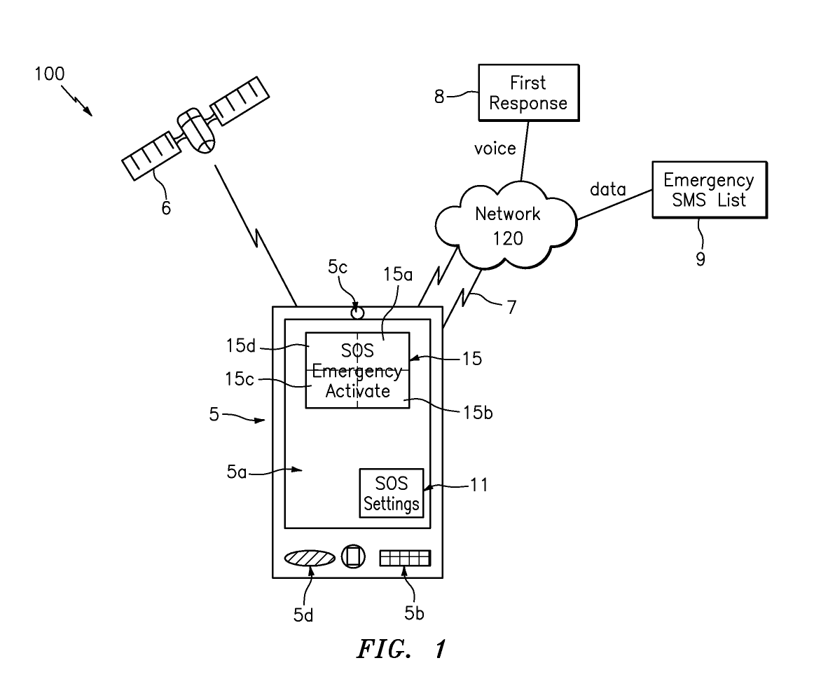

FIGS. 1-4 illustrate one embodiment of an emergency SOS application and system 100 that are useful for understanding the inventive concepts disclosed herein. As shown, in FIG. 1, the system can utilize a portable electronic device such as a smartphone, for example, to capture emergency information and transmit the same to others. In this regard, an emergency SOS application can be loaded onto a smartphone 5 that includes an actuation mechanism such as a keyboard, button and/or touch screen 5a, a microphone 5b, one or more cameras 5c, and/or a speakerphone function 5d.

As will be described below, the application can utilize the processing power, location tracking 6 and communicative abilities 7 of the smartphone to accurately determine a user's location, capture audio and/or video images (i.e., collectively referred to hereinafter as emergency data), and transmit the same to one or more emergency contacts during an emergency situation. These emergency contacts can include for example, calling a first response center 8, such as 911 to request medical or police assistance, and/or a list of user-provided emergency contacts 9.

A user's smartphone or tablet device generally includes installed software adapted to generate one or more screen icons at the instruction of an installed application. Two such icons that can be displayed as a part of the application can include the illustrated settings icon 11 and an EMERGENCY SOS ACTIVATE” ICON 15. As shown, it is preferred that the emergency icon 15 include a large footprint on the user screen. As screen icons typically include an identical size, one way of accomplishing this is to instruct the smartphone to generate a plurality of individual icons such as 15a, 15b, 15c and 15d, for example, that are linked together to form a shape such as a square or circle. As such, moving any one of the icons 15a-15d will function to move the remaining icons together. Likewise, engaging any single icon will launch the functionality described below. Each icon can also display a portion of a single image that is spread over each icon, so as to appear to be a single image. Such a feature results in the appearance of a single large icon on the display screen, so as to be quickly and easily identified by a user in an emergency situation.

In various embodiments, the network 120 is a transmission medium that facilitates any form or medium or digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a wireless network (e.g., RAN, code-division multiple access (CDMA) network, time division multiple access (TDMA) network, global system for mobile communications (GSM) network), infrared transmissions, Blue Tooth or Personal Area Networks (PANs), Near Frequency Communication (NFC) network, and/or other circuit-based networks.

Information transfer over the network 120 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

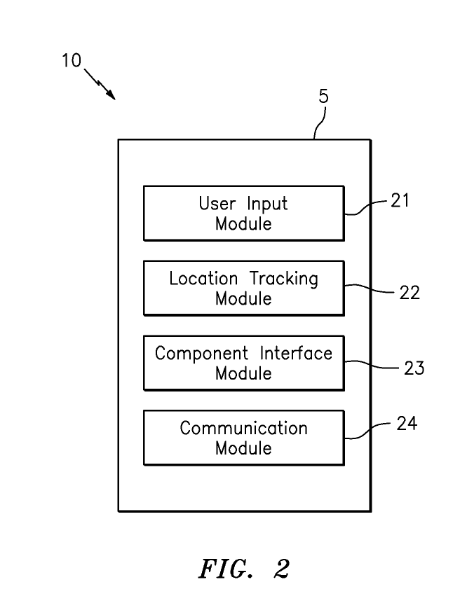

FIG. 2 illustrates one embodiment of the various modules which can be included in the downloaded application 10 and implemented into the smartphone 5. The modules can include a user input module 21, a location tracking module 22, a component interface module 23, and a communication module 24.

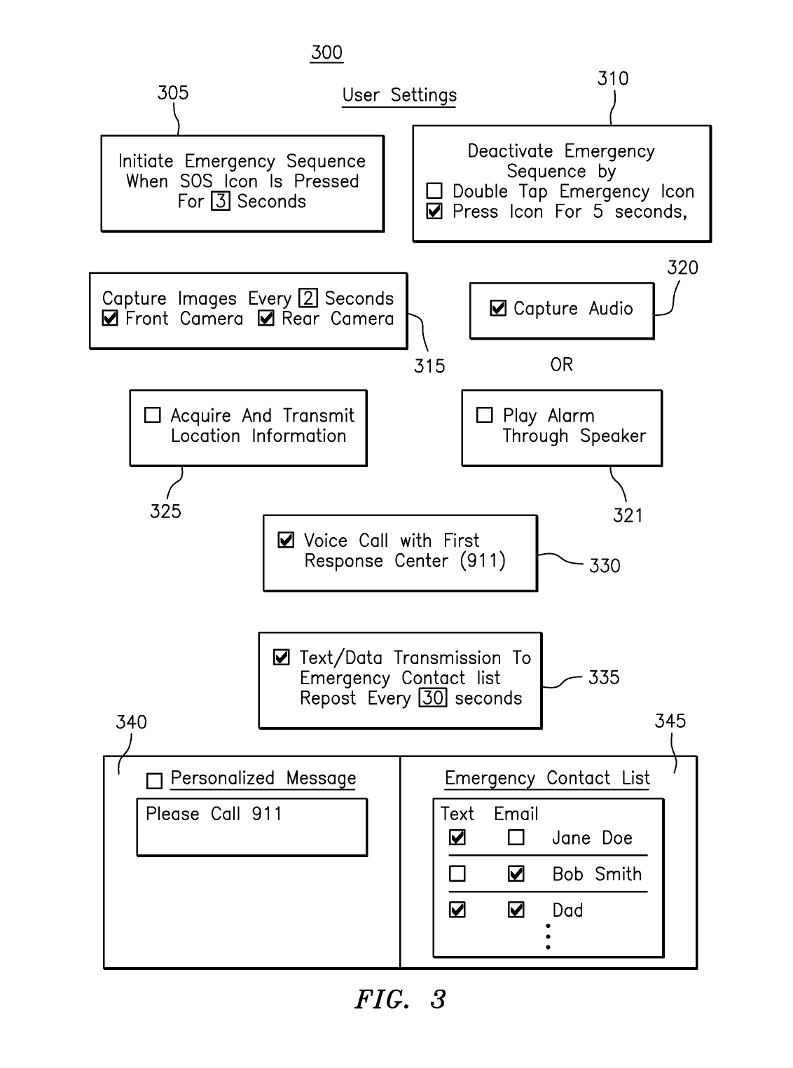

The user input module 21 can be accessible by the SOS settings icon 11 and can allow a user to establish their preferences and default settings for the app. In this regard, FIG. 3 illustrates an exemplary user Settings presentation screen 300 which can be generated by the application 10 to be displayed to a user on the smartphone device 5. As shown, the settings screen 300 can include an emergency sequence activation section 305, an emergency deactivation section 310, data capture options such as camera settings 315, audio settings 320 and 321, location information 325, and contact settings such as initiating a voice call with the first response center 330 and/or sending the captured emergency data to an emergency contact list 335. The system can also allow the user to send a personalized message 340, and to select/input a plurality of contacts to whom the data should be sent 345.

The location tracking module 22 can interface with the smartphones location identification features such onboard GPS and/or cellular triangulation, for example. In various embodiments, the module 22 can periodically capture the location information of the device 5, and store the same within the device memory, so as to be immediately available for transmission in an emergency situation. Additionally, once the SOS emergency feature has been activated by the user, the module 22 can continue to track the location of the user device. Such a feature can be particularly useful in a carjack or kidnapping situation, for example, so as to notify police and others of the location of the device that is moving from one location to another.

In addition to the above, the location tracking module can also interface with the devices 5 map and/or direction routing programs, such as GOOGLE MAPS, for example, so as to generate a map showing the location where the user is currently located. Moreover, when the emergency contact also has a stored address within the user device 5, the module 22 can generate turn by turn driving instructions that are unique to each person on the distribution list, and can send the same to the corresponding emergency contact. Such a feature can allow emergency contact list recipient to immediately travel to the reported location of the user, without having to consult a map or get lost along the way.

The component interface module 23 can interface with each of the peripheral components of the smartphone device 5, such as the microphone 5b, one or more cameras 5c, and/or loudspeaker 5d. In this regard, once the SOS emergency feature has been activated by the user, the module 22 can begin collecting emergency data from each of these devices, and can deposit this information into a textual communication for transmission to any number of different recipients on the emergency contact list. This procedure can continue based on the user settings until the emergency feature has been deactivated.

The communication module 24 can function to access each of the communicative abilities of the smartphone, such as voice, data and/or internet, for example. The module 24 can interact with each of the other modules 21-23 to generate and send data messages, as well as voice communication.

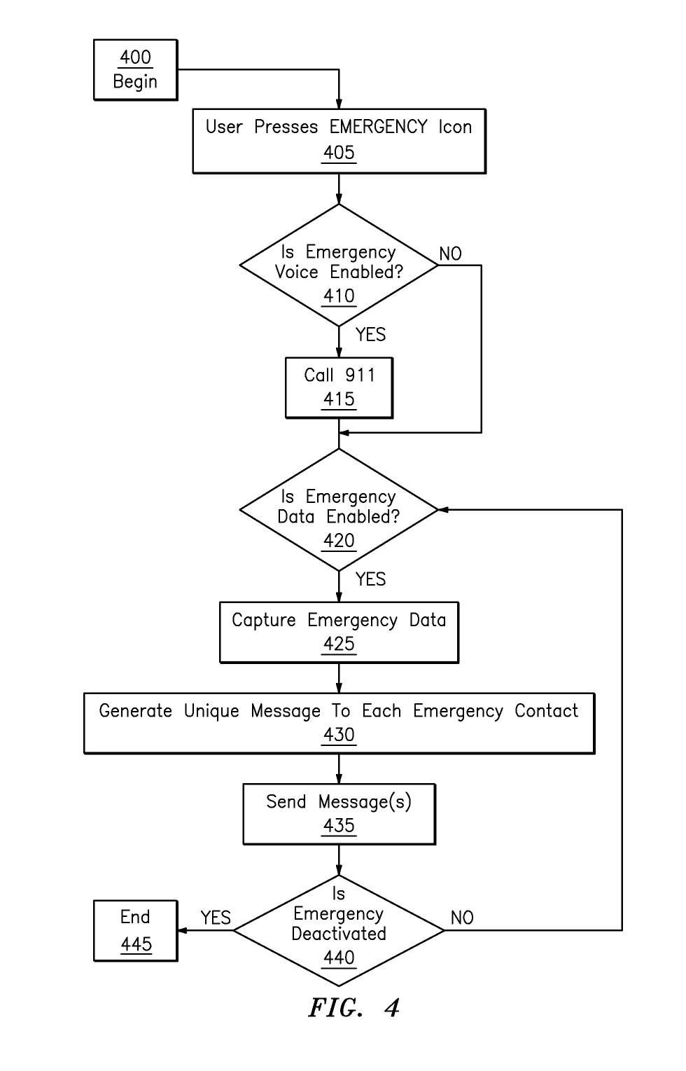

FIG. 4 is an exemplary method 400 that illustrates one embodiment of the emergency system 100 in operation utilizing the application 10 described above. As shown, the method can begin at step 405, wherein a user activates the emergency SOS icon 15 on their phone device. Next, the application can collect data and perform a communication routine based on the user instructions present in the User settings screen 300. To this end, the method can proceed to step 410, wherein a determination can be made if the voice call to 911 box 330 is enabled. If yes, the method can proceed to step 415, wherein the phone automatically dials 911 before proceeding to step 420. If no, the method can proceed directly to step 420.

At step 420, a determination can be made if the emergency contact list box 335 is enabled. If yes, the method can proceed to step 425 wherein each of the user selected device peripherals such as the microphone, speakerphone, and/or cameras, can begin capturing emergency data. Next, the method can proceed to step 430, wherein the application can generate data messages for each emergency contact, and can deposit the user-custom message 340, the device location information 325 and the data captured from the device at step 425 into each message, before sending the same at step 435.

Once each message has been sent, the application can determine if the user has deactivated the SOS application at step 440. If no, the method can return to step 420 wherein additional data messages can be generated and sent based on the information provided in box 335. If yes, the method can end at step 445.

Accordingly, the above described emergency SOS system can allow users to quickly and easily report an emergency situation to others, wherein the report can include their exact location, as well as photographs, video and/or audio of the incident. The system also can connect the user with 911 to provide voice assistance.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An emergency SOS system, comprising:
a portable electronic device that is configured to communicate over a network, said device including a display screen, an actuation mechanism, a processor, a memory, location information, and at least one of a microphone, a camera, and a speakerphone;
an emergency SOS application embodied in computer readable instructions that are encoded onto the device memory, for configuring the portable device to:
receive a notification of an emergency situation;
activate a voice telephone call with an emergency response center;
capture emergency data from each of the at least one microphone and camera; and
generate and send a data message containing the captured emergency data.

2. The system of claim 1, wherein the portable electronic device includes a generic smartphone device having each of the microphone, camera and speakerphone.

3. The system of claim 1, wherein the portable electronic device includes a smartphone device that is purpose built to execute the emergency SOS application.

4. The system of claim 3, wherein the purpose built smartphone device includes a separate physical internal memory onto which each of the emergency SOS application and the captured emergency data is stored.

5. The system of claim 1, wherein said receive a notification of an emergency situation includes the steps of:
generating an emergency icon;
displaying the emergency icon on the electronic device display screen; and
determining that the emergency icon has been depressed for a predetermined period of time.

6. The system of claim 5, wherein the emergency icon includes a size that is greater than a size of any other icon located on the display screen.

7. The system of claim 5, wherein the an emergency SOS application includes each of:
a user input module that functions to receive user-specified information;
a location tracking module that is in communication with the device processor;
a component interface module that is in communication with each of the at least one microphone, camera and speakerphone; and
a communication module that is configured to engage each of a voice and data communication network.

8. The system of claim 7, wherein the user input module generates a presentation screen for allowing a user to input or select at least one of:
the predetermined period of time for depressing the emergency icon;
a mechanism for deactivating an emergency sequence;
a camera image capture setting;
a microphone on/off setting;
a speakerphone on/off setting;
a voice call activation setting;
a data message generation setting;
a personalized message; and
a list of emergency contacts.

9. The system of claim 7, wherein the user input module generates a presentation screen for allowing a user to input or select each of:
the predetermined period of time for depressing the emergency icon;
a mechanism for deactivating an emergency sequence;
a camera image capture setting;
a microphone on/off setting;
a speakerphone on/off setting;
a voice call activation setting;
a data message generation setting;
a personalized message; and
a list of emergency contacts.

10. The system of claim 9, wherein the emergency SOS application is further configured to instruct the portable device to:
determine if an instruction to deactivate the emergency sequence has been activated; and
if determination is yes, then close the application;
if determination is no, then capture additional emergency data from each of the at least one microphone and camera; and
generate and send another data message containing the captured additional emergency data.

11. An emergency SOS application for execution by a portable electronic device that is configured to communicate over a network, and including a display screen, an actuation mechanism, a processor, a memory, location information, a microphone, a camera, and a speakerphone, said application comprising:
computer readable instructions that are encoded onto the device memory, for configuring the portable device to:
receive a notification of an emergency situation;
activate a voice telephone call with an emergency response center;
capture emergency data from each of the at least one microphone and camera; and
generate and send a data message containing the captured emergency data.
